(19) United States
(12) Patent Application Publication
(10) Pub. No.: US 2018/0002005 A1
(43) Pub. Date: Jan. 4, 2018

(54) Aircraft

(71) Applicant: Felix Errol Groenewald, Centurion (ZA)

(72) Inventor: Felix Errol Groenewald, Centurion (ZA)

(21) Appl. No.: 15/545,214

(22) PCT Filed: Jan. 13, 2016
(86) PCT No.: PCT/ZA2016/000002

§ 371 Date: Jul. 20, 2017

(30) Foreign Application Priority Data
Jan. 21, 2015 (ZA) 2015/00430

(51) Int. Cl. B64C 27/41; B64C 27/52; B64C 27/12

(52) U.S. Cl. CPC B64C 27/41; B64C 27/12; B64C 27/52

(57) ABSTRACT

A helicopter with a rotor pivotally connected to a shaft by a universal joint or ball and socket joint. The helicopter includes: a fuselage; a rotor mast that is fixed against relative rotation with respect to the fuselage; at least one blade; a motor for rotating the at least one blade; and a universal joint or ball and socket joint. The universal joint or ball and socket joint: (i) is disposed between the at least one blade and the rotor mast, with the at least one blade being rotatable relative to the universal joint or ball and socket joint; (ii) is disposed between the motor and the rotor mast; and (iii) is fixed against relative rotation with respect to the rotor mast, such that, pivoting of the universal joint or ball and socket joint causes the at least one blade and the motor to tilt.

### BACKGROUND

The present invention relates to an aircraft having a rotor pivotally connected to a rotor mast.

Aircraft with pivotally attached rotors are known. For example:
US2005/0196275 “Rotor head for a rotary-wing aircraft” to Carson and US2010/0003886 “Model helicopter” to Cheng and Matloff describe a rotor that is pivotally connected to a mast via a ball and socket joint, wherein: (i) the ball is connected to the mast, (ii) the socket is connected to the rotor, and (iii) the ball and socket are rotatable relative to each other.
U.S. Pat. No. 2,162,794 “Rotary wing aircraft” to Asboth, U.S. Pat. No. 2,384,516 “Aircraft” to Young and U.S. Pat. No. 2,510,006 “Rotating wing aircraft” to Young describe a helicopter with a rotor connected to a rotor mast via a ball and socket joint, wherein the rotor, rotor mast and ball and socket joint are fixed against relative rotation with respect to each other.
US2010/0264256 “Counter-rotational inertial control of rotorcraft” to Yim and

Thorne describes a rotor that is rotatably connected at its radial outer end(s) to an aircraft via a universal joint.
U.S. Pat. No. 5,360,364 “Cardan joint for a toy building set” to Poulsen and Hatting describes a toy helicopter including: (i) a fuselage, rotating shaft, (ii) a cardan ball fixed to the shaft and rotatable with the shaft, (iii) a rotor fixed to the upper portion of the cardan ball and rotatable with the cardan ball, (iv) a guide ring that is rotatably secured to the bottom portion of the cardan ball but fixed against relative rotation with respect to the fuselage, and (v) actuators extending between the fuselage and guide ring to control tilt of the rotors.
U.S. Pat. No. 4,073,600 “Damping mechanism for the rotor hub of a helicopter for ground resonance and waddle and its combination with the rotor” to Doman describes a cylindrical rotor pylon with a drive shaft extending therealong. A universal joint is secured to the pylon, with rotor blades rotatable secured to the universal joint. The rotor pylon and universal joint are not rotatable relative to the fuselage. However, a second universal joint is required to transfer torque from the drive shaft to the blades.

Drawbacks of known arrangements are that: (i) parts of the universal joint or ball and socket joint disposed between the rotor mast and blades rotate relative to each other causing wear and complicating control over tilt of the rotor; or (ii) the drive shaft for transferring power from the motor to the rotor requires a universal joint or ball and socket joint to cater for tilt of the rotor.

The aircraft according to the present invention aims to addresses the above drawbacks by connecting blades to a rotor shaft by a universal joint or ball and socket joint that is not rotatable relative to the rotor shaft, and mounting the motor to the universal joint or ball and socket joint (either directly or via a collar).

### SUMMARY OF THE INVENTION

According a preferred embodiment of the present invention, there is provided an aircraft that includes:
a fuselage;
a rotor mast that is fixed against relative rotation with respect to the fuselage;
at least one blade;
a motor for rotating the at least one blade; and
a universal joint or ball and socket joint;

characterised in that the universal joint or ball and socket joint:
(i) is disposed between the at least one blade and the rotor mast, with the at least one blade being rotatable relative to the universal joint or ball and socket joint;
(ii) is disposed between the motor and the rotor mast; and
(iii) is fixed against relative rotation with respect to the rotor mast,

such that, pivoting of the universal joint or ball and socket joint causes the at least one blade and the motor to tilt. Alternatively, the aircraft includes two sets of blades that are axially spaced from each other, the universal joint or ball and socket joint providing for pivoting of the axially spaced sets of blades substantially about the resultant centre of rotation of the blades.

Typically, the universal joint or ball and socket joint provides for pivoting of the at least one blade substantially about its centre of rotation.

Generally, the aircraft further includes a collar secured to the universal joint or ball and socket joint, wherein: (i) the universal joint or ball and socket joint is disposed between the collar and rotor mast; and (ii) the at least one blade is rotatably connected to the collar.

Preferably, a portion of the radial outer wall of the collar is right circular cylindrical.

Typically, the aircraft further includes limiters for limiting pivoting of the collar about the rotor mast to between +20 degrees and −20 degrees.

Generally, the collar is integral to a part of the universal joint or ball and socket joint.

Preferably, a circular bearing is disposed between the collar and the at least one blade.

Typically, the aircraft includes: (i) a pair of blades; or (ii) two axially spaced, concentric pairs of blades.

Generally, the aircraft further includes at least two actuators for tilting the collar relative to the rotor mast, wherein the actuators are fixed against rotation with respect to both the collar and the rotor mast.

Preferably, the motor is either an electric motor or a hydraulic motor.

Typically, the motor is mounted radially outwards of the collar.

### BRIEF DESCRIPTION OF THE DRAWINGS

The invention will now be described in more detail, by way of example only, with reference to the accompanying drawings in which:

FIG. 1 is a side view of an aircraft according a preferred embodiment of the present invention;

FIG. 2 is a perspective cross sectional view of the rotor section of the aircraft in FIG. 1; and

FIG. 3 is a side cross sectional view of the rotor section of the aircraft in FIG. 1; and

FIG. 4 is a side cross sectional view of the rotor section of the aircraft in FIG. 1 with the collar, motor and blades tilted relative to the rotor mast.

### DESCRIPTION OF A PREFERRED EMBODIMENT

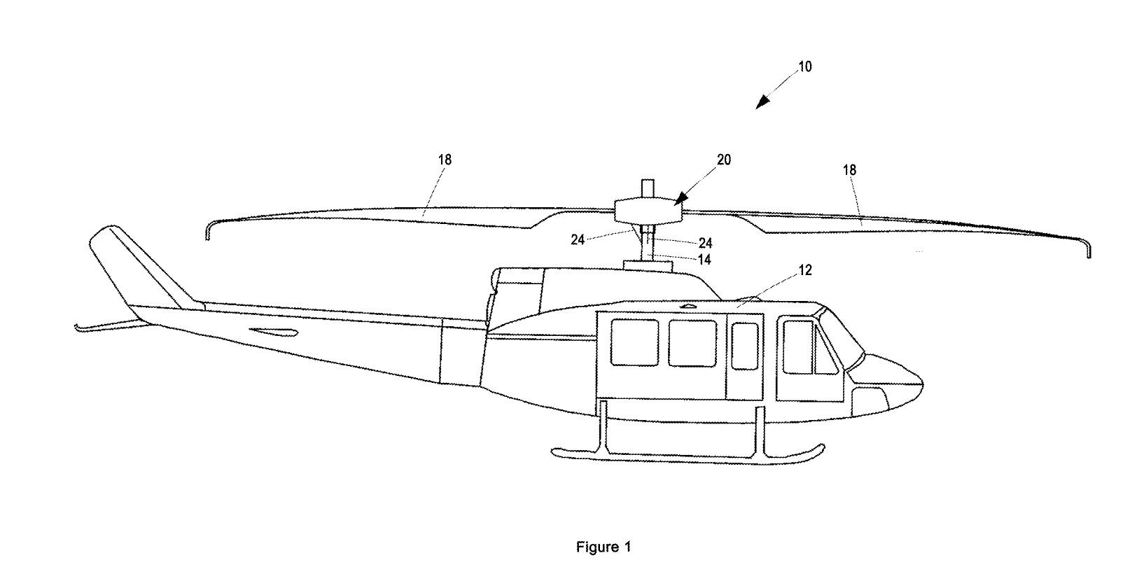

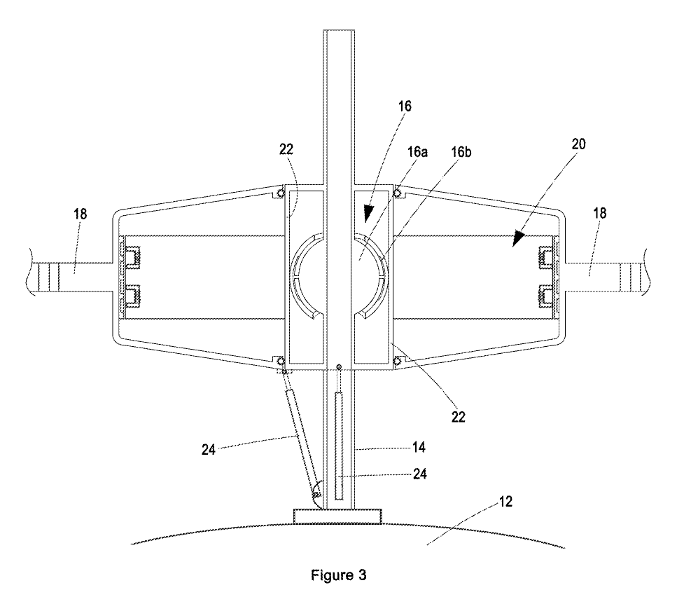

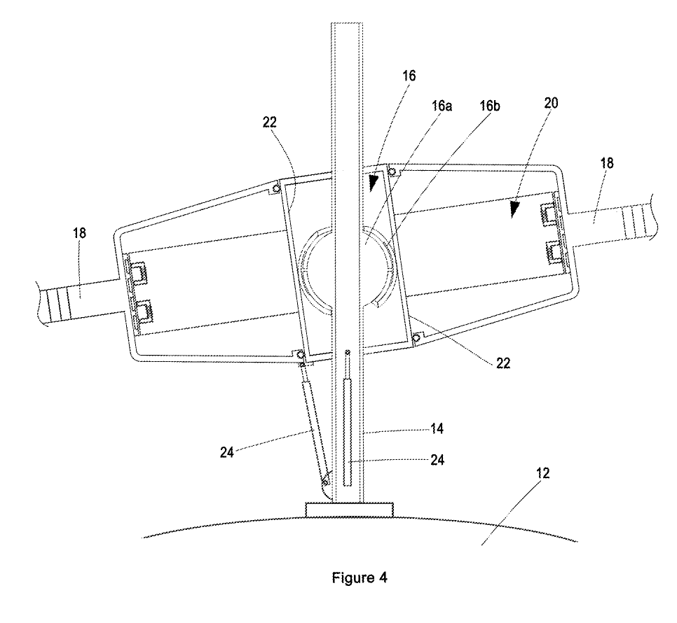

With reference to FIGS. 1 to 4 of the drawings, an aircraft 10 according to a preferred embodiment of the invention is in the form of a helicopter that includes a fuselage 12, a rotor mast 14, a universal joint or ball and socket joint 16, a rotor comprising a pair of blades 18, and a motor 20 for rotating the blades 18.

The rotor mast 14 is a cylindrical rod that is fixed to the fuselage 12 in a manner so as to prevent relative rotation between the rotor mast 14 and fuselage 12.

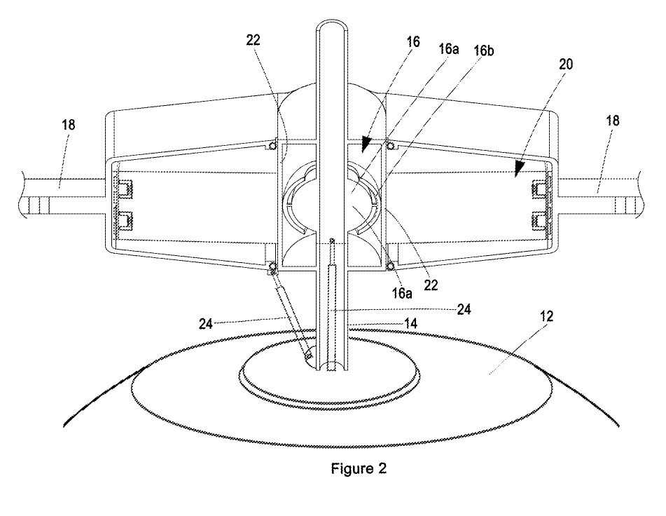

The universal joint (sometimes referred to as a gimbal joint) or ball and socket joint 16 is connected to the rotor mast 14 at or near the operative top axial end of the rotor mast 14. FIGS. 2 to 4 show the joint 16 as a ball and socket joint with the spherical ball portion 16a being secured to/formed by the rotor mast 14. The socket portion 16b of the ball and socket joint 16 defines a spherical concave recess sized and shaped to receive the ball portion 16a. The entire ball and socket joint 16 (i.e. the ball portion 16a and the socket portion 16b) are fixed against relative rotation with respect to the rotor mast 14. To prevent rotation of the ball portion 16a relative to the socket portion 16b, the ball portion 16a could include a protrusion extending radially outwards from the ball portion 16a, and the socket portion 16b could define an axially extending linear recess defined, which linear recess is sized and shaped to receive the protrusion therein and therealong. However, various alternative arrangements to prevent relative rotation of the ball portion 16a and socket portion 16b are envisaged.

In essence, the universal joint 16 is a spherical slip joint that conveys limited dynamic force. It provides a fulcrum point from which the angle of the rotor 18 plane can be varied while altering the centre of gravity of the aircraft 10 only slightly.

It will be appreciated that the ball and socket joint 16 could be substituted with joints that permit universal pivoting movement, such as a universal joint (i.e. a joint including an inner gimbal and an outer gimbal with orthogonal pivot axes).

A collar 22, which defines a right circular cylindrical portion is either connected to or integral to the socket potion 16b of the ball and socket joint 16. The collar 22 provides: (i) a right circular cylindrical outer radial surface to facilitate rotation of the blades 18 thereabout; and (ii) a structure upon which to mount the motor 20. Furthermore, the collar 22 could be used as a limiter, limiting pivoting of the ball and socket joint 16 by contact between the collar 22 and the rotor mast 14. Preferably, limiters limit pivoting of the ball and socket joint 16/tilting of the collar 22 to between +20 degrees and −20 degrees from the neutral position (i.e. the position where the collar 22 is co-axial with the rotor mast 14). The collar 22 is fixed against relative rotation with respect to the rotor mast 14.

The motor 20 is mounted to the collar 22 (whether radially outwards of, above and/or below the collar 22) and fixed against relative rotation with respect to the collar 22. The motor 20 is either a hydraulic motor or an electric motor (whether axial or radial flux electric motor). FIGS. 2 to 4 show the motor 20 as an electric motor. It will be appreciated that only the parts of the motor 20 that generate drive/torque (e.g. the electro-magnets and permanent magnets of an electric motor/the motor rotor and stator(s)) need be located on the collar 22. For instance, generators, batteries, inverters, condensers, pumps, control boxes etc. (not shown) could be located within the fuselage 12 and connected to the motor 20 via flexible leads or pipes.

It will be appreciated that, with the motor 20 mounted to the collar 20, pivoting of the ball and socket joint 16 causes the collar 22 and motor 20 to tilt relative to the fuselage 14.

The blades 18 have an aerofoil cross-section, and are rotatably connected to the collar 22 via a circular bearing. It will be appreciated that the blades 18 may be connected indirectly to the collar 22 via the motor 20. Although the Figures show a helicopter 10 with two blades 18 extending co-axially from the rotor mast 14, the two blades could comprise a single blade 18 or a set of three or more equi-spaced blades 18. Furthermore, the collar 22 could support two axially spaced, concentric sets of blades (e.g. a pair of counter-rotating rotors).

The blades 18 are configured such that their centre of rotation substantially coincides with the centre of pivot of the ball and socket joint 16. By “substantially”, it is meant that the centre of rotation of the blades 18 is displaced from the centre of pivot of the ball and socket joint 16 by less than 0.05×the length of the rotor (i.e. the diameter of the rotor). In other words, the longitudinal axis of the blades 18 should substantially travel through the centre of the ball portion 16a of the ball and socket joint 16. In such arrangement, pivoting of the ball and socket joint 16 causes the blades 18 to tilt without causing significant weight shift of the aircraft 10.

It will be appreciated that the collar 22 could include a set of upper blades 18 and a set of lower blades 18, which upper and lower sets of blades 18 are axially spaced from each other. Preferably, the upper set of blades 18, in use, counter-rotates relative to the axially spaced lower set of blades 18. In such configuration, the centre of rotation of the rotor (i.e. the combined upper and lower sets of blades 18) secured to the collar 22 is located halfway between the upper set of blades 18 and the lower set of blades 18. In this specification “resultant centre of rotation” (insofar as it is used in respect of the blades 18), means a point halfway between: (i) the centre of rotation of the upper set of blade(s) 18; and (ii) the centre of rotation of the axially spaced lower set of blade(s) 18. The present invention is intended to cover such arrangement. An advantage of this arrangement, i.e. an aircraft 10 with axially spaced, counter-rotating sets of blades 18 secured to a collar 22, is that the collar 22 only transfers the net torque generated by the axially spaced rotors/motors 20 to the mast 14 via the ball and socket joint 16. This significantly reduces torque transfer through the ball and socket joint 16, in use.

A pair of actuators 24 extend directly or indirectly from: (i) the collar 22 or motor 20 on the one hand; and (ii) the rotor mast 14 or fuselage 12 on the other hand—retraction or extension of the actuators controlling pivoting of the ball and socket joint 16 and tilting of the collar 22, motor 20 and blades 18. The actuators 24 are fixed against relative rotation with respect to the collar 22, motor 20, rotor mast 14 and fuselage 12.

Optionally, a parachute (not shown) is located at the top of the rotor mast 14, above the blades 18. Since the rotor mast 14 does not rotate, the parachute may safely be deployed in flight without entangling with the rotor and entwining the parachute cords.

In use, the motor 20 rotates the blades 18. Should the pilot (not shown) wish to move the helicopter 10 forward, the actuators 24 cause the collar 22 to tilt forward, causing the blades 18 and motor similar to tilt forward, which forward tilt relative to the mast 14 and fuselage 12 is permitted by the ball and socket joint 16. Similarly, backwards and sideward movement of the helicopter 10 is caused by tilting the collar 22 to tilt backwards and sideways, respectively.

It will be appreciated that, since the two pivoting portions 16a and 16b of the ball and socket joint 16 are fixed against relative rotation with respect to each other, wear of the ball and socket joint 16 is reduced. Furthermore, since the motor 20 is mounted to the collar 22, and tiltable with the blades 18, the motor 20 drive shaft (if any) (not shown) does not require a universal or flexible joint to cater for tilting of the blades 18. Even further, since the collar 22 and fuselage 12 are fixed against relative rotation with respect to each other, control over tilting of the collar 22 (and, thereby the blades 18) is simplified. Additionally, by mounting the motor 20 to the collar 22, in close proximity to the blades 18, the blades 18 can be rotated at higher speeds relative to conventional rotors powered by a driveshaft.

1. An aircraft including:
a fuselage;
a rotor mast that is fixed against relative rotation with respect to the fuselage;
at least one blade;
a motor for rotating the at least one blade; and
a ball and socket joint;
characterised in that ball and socket joint:
(i) is disposed between the at least one blade and the rotor mast, with the at least one blade being rotatable relative to the ball and socket joint;
(ii) is disposed between the motor and the rotor mast;
(iii) is fixed against relative rotation with respect to the rotor mast; and
(iv) includes a radially extending protrusion and defines a linear recess that is sized and shaped to receive the protrusion therein and therealong, which protrusion and recess co-operate to permit relative tilting while preventing relative rotation of the ball and the socket,
such that, pivoting of the ball and socket joint causes the at least one blade and the motor to tilt.

2. An aircraft according to claim 1, wherein the ball and socket joint provides for pivoting of the at least one blade substantially about its centre of rotation.

3. An aircraft according to claim 2, further including a collar secured to the ball and socket joint, wherein: (i) the ball and socket joint is disposed between the collar and rotor mast; and (ii) the at least one blade is rotatably connected to the collar.

4. An aircraft according to claim 3, wherein a portion of the radial outer wall of the collar is right circular cylindrical.

5. An aircraft according to claim 4, further including limiters for limiting pivoting of the collar about the rotor mast to between +20 degrees and −20 degrees.

6. An aircraft according to claim 5, wherein the collar is integral to a part of the ball and socket joint.

7. An aircraft according to claim 6, wherein a circular bearing is disposed between the collar and the at least one blade.

8. An aircraft according to claim 7, including: (i) a pair of blades; or (ii) two axially spaced, concentric pairs of blades.

9. An aircraft according to claim 8, further including at least two actuators for tilting the collar relative to the rotor mast, wherein the actuators are fixed against rotation with respect to both the collar and the rotor mast.

10. An aircraft according to claim 9, wherein the motor is either an electric motor or a hydraulic motor.

11. An aircraft according to claim 10, wherein the motor is mounted radially outwards of the collar.

12. An aircraft according to claim 1, wherein the aircraft includes two sets of blades that are axially spaced from each other, the ball and socket joint providing for pivoting of the axially spaced sets of blades substantially about the resultant centre of rotation of the blades.
